(19) United States
(12) Patent Application Publication
(10) Pub. No.: US 2007/0020353 A1
(43) Pub. Date: Jan. 25, 2007

(54) Brake-shoe wear sensor

(75) Inventor: Christian Kainrath, Rankwell-Brederis (AU)

Correspondence Address: THE FIRM OF KARL F ROSS, 5676 RIVERDALE AVENUE, PO BOX 900, RIVERDALE (BRONX), NY, 10471-0900, US

(73) Assignee: Hirschmann Automotive GmbH

(21) Appl. No.: 11/481,398

(22) Filed: Jul. 5, 2006

(30) Foreign Application Priority Data
Jul. 5, 2005 (DE) 102005031328.0

(51) Int. Cl. B29C 45/00; B60Q 1/44

(52) U.S. Cl. 425/562; 340/479; 200/315; 73/1.15

(57) ABSTRACT

A sensor or actuator for mobile use has a housing containing means for determining or affecting an operating parameter, the housing being made of X6952 plastic.

### FIELD OF THE INVENTION

The present invention relates to a sensor or determining an operating parameter of a system. This invention also concerns an actuator with means for setting a variable of a system.

### BACKGROUND OF THE INVENTION

Sensors or actuators with means for determining or setting a parameter of a system are known. With them it is important that the mens fo determining or setting the variable or operating parameter be protected in a housing from surrounding environmental conditions. The housing is preferably of a heat-resistant plastic since temperature is normally a particular problem. Such plastic housings surround the means for setting or determining the operating parameter or variable. According to construction type, the sensor or actuator also has a cable connection that is also made of het-resistant plastic so that signals can be fed in or out of the sensor or actuator.

When such sensors or actuators are used in fixed locations, the choice of materials for the plastic of the housing is not highly significant, since in such applications the factors such as temperature, pressure, moisture, water, and the like that might affect the housing of the sensor or actuator can easily be taken into account. This is however not the case in sensors or actuators in mobile applications since vibration and noise are a particular problem then.

### OBJECTS OF THE INVENTION

It is therefore an object of the present invention to provide an improved actuator or sensor with means for determining or setting an operating parameter or variable that is particularly well protected against environmental conditions.

Another object is the provision of such an improved actuator or sensor with means for determining or setting an operating parameter or variable, in particular that is well protected against environmental conditions that overcomes the above-given disadvantages.

More particularly the housing for such a sensor or actuator should have the necessary mechanical stability and above all avoid the generation of annoying noise.

### SUMMARY OF THE INVENTION

A sensor or actuator for mobile use according to the invention has a housing containing means for determining or affecting an operating parameter, the housing being made of X6952 plastic.

This plastic is a thermosetting resin that has the advantage that it very effectively shields what it is containing against environmental influences from outside, while still offering the necessary mechanical stability, which is particularly important when the sensor or actuator is mounted on another piece of equipment. The particular advantage of X6952 plastic, made by Vyncolit, is that in mobile us as a sensor actuator it suppresses or completely eliminates noise generation.

Furthermore according to the invention the plastic housing is made by injection molding. It is extremely efficient and inexpensive to put the “works” or means of the sensor or actuator in a mold and to form the plastic housing right around it so as to fully encapsulate such “works.” If necessary the works are coated or covered with a protective layer before the plastic housing is molded around them.

A particular application of the heat-resistant X6952 plastic is when the plastic housing is used in a motor vehicle. Such mobile application is particularly likely to generate noise, so that the noise-reducing or -eliminating characteristics of this resin are particularly important. When used in a brake-shoe wear detector such as described in commonly owned U.S. patent application Ser. No. 11/364,806 filed 28 Feb. 2006 the hitherto considerable problem of noise is almost completely cured. Of course the instant invention is not limited to such use.

Vincolit X6952 is a high glass-fiber reinforced phenolic resin. It has a density (ISO 1183) of 1.71 g/cm ³, a flex strength (ISO 178) of at least 250 MPa, a flex modulus (ISO 178) of at least 16 GPa, a flex strain (ISO 178) of at least 1.5%, and a tensile strength (ISO 527) greater than 100 MPa.

I claim:

1. In a sensor or actuator for mobile use having a housing containing means for determining or affecting an operating parameter, the improvement wherein the housing is made of X6952 plastic.

2. The improvement defined in claim 1 wherein the plastic housing is made by injection molding.

3. The improvement defined in claim 1 wherein the plastic housing is used in a motor vehicle.

4. The improvement defined in claim 1 wherein the means is a brake-shoe wear detector.
